(19) United States
(12) Patent Application Publication
(10) Pub. No.: US 2004/0005910 A1
(43) Pub. Date: Jan. 8, 2004

(54) Methods and apparatus for a self-configuring smart modular wireless device

(76) Inventor: Alfred Tom, Lafayette, CA (US)

Correspondence Address: Alferd Tom, 732 St. Mary's Rd., Lafayette, CA, 94549, US

(21) Appl. No.: 10/606,178

(22) Filed: Jun. 24, 2003

Related U.S. Application Data
(60) Provisional application No. 60/391,490, filed on Jun. 25, 2002.

(51) Int. Cl. H04M 3/00

(52) U.S. Cl. 455/558; 455/550.1; 455/418

(57) ABSTRACT

A smart modular wireless device is divided into two main parts—the cartridge contains wireless components and the shell contains non-wireless components. Software applications on the shell may register for various wireless services, and then configure themselves based on the services supported by the cartridge. Once connected to the shell, the cartridge may download software to the shell that may replace or upgrade the software already in the shell. The cartridge and shell may exchange information to synchronize user data or exchange subscriber information. The shell may be locked so that only approved cartridges can be used with the shell. The cartridge may be locked from unauthorized use. The cartridge and shell may support a protocol that enables the user to enter information a specific cartridge needs to operate. The protocol may also enable the cartridge to communicate notices and messages to the user that are specific to the characteristics the cartridge. Thus a smart modular wireless device can maintain flexibility with air-interface standards and configure its operation according to the type of cartridge inserted.

This application is based upon provisional application No. 60/391,490 with a filing date of Jun. 25, 2002.

### FIELD OF THE INVENTION

The present invention is generally directed to wireless communication devices and related apparatus. More particularly, this invention relates to a smart modular wireless device with features that allow it to self-configure its operation.

### BACKGROUND OF THE INVENTION

The components of a wireless device can be separated into two categories—wireless components and non-wireless components. Wireless components include the baseband section, the RF section, antenna, and/or the call-processing software. The call-processing software is sometimes called the “protocol stack software”. Non-wireless components are comprised of everything else, which include the keypad, display, battery, speaker, and/or microphone.

There are at least three architectures used in wireless devices today. The first architecture, utilized by the large handset vendors such as Nokia and Motorola, puts both wireless and non-wireless components on a single circuit board. The second architecture, used by smaller vendors such as TCL and Handspring, puts the wireless components on a separate board called a wireless module and leaves the non-wireless components on the main circuit board. The wireless module is affixed to the circuit board. In this architecture the antenna is connected to the main circuit board and it not included in the wireless module. The third architecture improves on the second architecture by making the wireless module into a card that can be removed from the device at any time. The prime example of this third architecture is the Hydra™ system, invented by Alfred C. Tom and protected by patent pending U.S. application Ser. No. 09/276,480 filed on Mar. 25, 1999.

In the rest of this document, we will refer to the collection of wireless components (whether bundled in a removable card or not) collectively as the “cartridge”. We will refer to the non-wireless components collectively as the “shell”. We will allow the antenna to reside in either the cartridge or the shell.

Modular wireless devices are those in which there is a separation between the cartridge and shell. With the first wireless device architecture this separation is logical since all components are on the same circuit board. With the other two architectures this separation is physical. The purpose of modularity is to help with the design process. It is easier to design and debug a modular device than a non-modular device. In the case of devices that conform to the third architecture, modularity also enables flexibility with air—interface standards since cartridges that support different standards can be interchanged. For example, a GSM cartridge for GSM can easily be replaced by a CDMA cartridge.

Although modular devices are an improvement over non-modular devices, there are limitations that are evident in current-art modular wireless devices. These limitations are related to the fact that current devices cannot configure themselves according to the type of cartridge used. One limitation is lack of standards flexibility in software applications. Currently, software applications in the shell must be written for a specific air-interface standard. For example, an application for GSM is written differently than an application for Wi-Fi. Although a shell's hardware may be able to support different air—interface standards using a technique like interchangeable cartridges or a technique like a software-defined radio (SDR), the shell's application software may still require modification to take advantage of a different air-interface standard. For example, an application written to run on a GSM handset will not use all the capabilities of a GSM/Bluetooth handset because the application does not have knowledge of, nor does it know how to use, the new Bluetooth capabilities. Worse, if the GSM application were to run on a Wi-Fi Voice over IP handset, the application may not even work because Wi-Fi has much different characteristics than GSM. This limitation forces device vendors to support different code bases for the same software application, adding cost and complexity to application development and maintenance efforts.

The interchangeable cartridge system described by third wireless device architecture reveals further limitations to the current-art modular wireless device. One such limitation is the inability to upgrade or replace the system software in the shell when a new cartridge is inserted into the shell. For example, if a user replaces a Sprint PCS cartridge in the shell with a cartridge for Verizon, it may be advantageous to change the system software in the shell to conform to Verizon's specifications rather than Sprint's specifications. For example, Verizon system software might have a different user-interface than Sprint software.

Handspring used to market a handheld computer with a slot that allows the insertion of Springboard modules. The Springboard interface allows a module to download application and driver software to the handheld. However, the Springboard interface contained no provision for changing the actual user interface of the hand-held, and the software being downloaded is often deleted once the module is removed. Furthermore, applications already resident on the computer often cannot use the advanced features in a Springboard module.

Another limitation of the current art is the lack of subscriber information management when cartridges are being interchanged. If the subscriber information is stored on the cartridge, this information will be lost when the cartridge is replaced with another cartridge. This loss prevents the user from keeping the same phone number and other information while interchanging cartridges. However, if the shell contains the subscriber information instead of the cartridge, swapping one cartridge among different shells such as cars and PDAs becomes difficult because holding different subscriber information on each shell is inconvenient. For example, if a user uses two different handsets, there is no way to have the same phone number for different shells. Last, if both the cartridge and shell contain subscriber information, the cartridge and shell may have conflicting identities.

Some GSM wireless modules place the subscriber identity in a SIM card off the GSM module. This allows different modules to be used with the same SIM card. However, GSM modules are not swappable so roaming between wireless standards is not possible. Furthermore, some networks do not use SIM cards.

Some handsets have the ability to hold two phone numbers (one for work and one for personal, for example). However, these handsets cannot use phone numbers for different wireless networks and changing phone numbers on the fly is not possible.

There also exists synchronization products that reconcile two different databases, such as Palm desktop software and FusionOne. However, these synchronization techniques permanently alter the information of the two devices. This permanent alteration prevents the cartridge from reverting back to the original subscriber info once it is removed from the shell. As a result, the cartridge loses its subscriber information and is now inoperable in a shell that does not have its own subscriber information.

Another problem exists when both the shell and cartridge contain user data such as stored phone numbers. In this case, it is unclear whether the user should access the stored numbers in the shell or the card. If the user is able to access the stored numbers in the shell, stored number in the cartridge cannot be accessed. If the user is able to access stored numbers in both the shell and cartridge, there may be inconsistent data or double entries. One can give the user the choice of which stored numbers to access, but this adds unnecessary complication to dialing a stored number.

Yet another limitation of the current art is security. If a network operator (“NO”) sells the shell to the consumer at a loss (i.e.—subsidizes the shell) in hopes of realizing airtime revenue in the future, the NO may only want the shell used with the NO's cartridges. Otherwise, the user can use the subsidized shell on another network and the NO would not have airtime revenue. With the current art, there is no way to limit the types of cartridges that can be used by the shell. Furthermore, if a cartridge is lost or stolen there is no way to prevent the cartridge from being used by an unauthorized person.

Some GSM handsets have a locking mechanism that prevents the handset and/or SIM card from being used without entering the proper pass code. This allows network operators to give customers a free phone and make sure the phone will be used only with the network's SIM cards. To use a foreign SIM card, the user must enter the correct pass code. SIM cards can also be locked to prevent fraudulent use should the customer lose the SIM card. However, these locking mechanisms only pertain to SIM cards, not cartridges. They do not limit the types of cartridges that can be used in a shell, nor do they prevent unauthorized people from using a lost or stolen cartridge.

A final limitation of the current art is the inability to relay information specific to a certain cartridge back and forth between the cartridge and user. Some cartridges need certain communication preference values in order to operate. Often these values are obtained from the user. For example, a GSM cartridge that supports SMS may need the number of the SMS messaging center. A Wi-Fi cartridge may require an IP address to receive data over IP networks. There are also situations in which the cartridge needs to communicate a message to the user that is specific to a certain capability in the cartridge. For example, if the cartridge is a WLAN card, it needs to notify the user when the device is no longer connected to a WLAN. In another example, a roaming GSM cartridge needs to tell the user which networks are available to roam on so the user may choose a network to use.

The current art does not address adequately the issue of cartridges obtaining user-input information. In the current art, handsets have user-input windows that allow the user to input the necessary values according to the air-interface standard of the handset. However, with devices that can change to any air-interface standard on the fly there is no way for a shell to include all the possible user-input windows. Windows-based PCs use PC Cards to access different communication services such as LANs and phone lines. PC Cards communicate with the user via built-in Windows software and card-specific software that must be installed before the PC Card can be used. However, installing new software onto a wireless device via a CD-ROM or disk is infeasible given the available input hardware of a shell. It is also a complicated process for many users.

The current art also does not address adequately the issue of communicating cartridge-specific messages to the user. In the current art, handsets pre-define user messages according to the capabilities of the handset. When an event needs to be communicated to the user, the handset uses the applicable pre-defined message. However, with devices that conform to the third architecture it is impossible for a shell to predict all the messages needed for every type of cartridge.

Without more intelligence, modular wireless devices will be limited in their operation. The industry needs a way to build modular wireless devices that can configure operation based on changes in the cartridge. The present invention addresses these needs.

### SUMMARY OF THE INVENTION

The present invention provides methods and apparatus directed to a smart modular wireless device that is able to configure, reconfigure, or adapt its operation. The present invention applies to all three device architectures mentioned above, but is most useful to the third architecture.

A smart modular wireless device may consist of a cartridge and a shell. The cartridge may consist of wireless components such as baseband, RF, and call-processing software. The shell may consist of non-wireless components such as keypad, display, battery, speaker, and microphone. The cartridge and shell components may be located on the same circuit board. Alternatively, the cartridge may be in the form of a wireless module or a removable card.

The cartridge and shell may communicate information to each other over an interface. The cartridge and shell may use this information to configure, reconfigure or adapt their operation. The cartridge may communicate to the shell a list of the wireless services it supports. This information may allow the shell to configure itself to access these new services and notify software applications of the availability of new services. Software applications may then adapt their operation according to the wireless services available in the cartridge. As a result this aspect of the invention, applications are able to reconfigure themselves to support new wireless services. Device vendors do not need to maintain separate code bases for an application because a single software application can reconfigure itself based on the air-interface standard of the cartridge and the services offered by the cartridge

In another aspect of the invention, a smart modular device may support a removable cartridge architecture. In this architecture, different cartridges may be inserted into the shell on the fly and the shell and cartridge may exchange information when they are connected. This information may be related to the type and version of system software in the shell. Based on this information, the cartridge may initiate a software upgrade process whereby system software in the shell is replaced by replacement software in the cartridge. In this manner, the smart modular device may upgrade the shell's system software when a new cartridge is inserted. This may allow a shell to be modified on the fly to meet a specific operator's specifications. For example, system software that supports the Sprint network may be replaced by system software that supports the Verizon network.

Another aspect of the invention also involves a smart modular device with removable cartridges. In this smart modular device, the cartridge and shell may contain memory storage bins (“bins”) to store subscriber information (SI) and user data. The cartridge and shell may communicate information to determine whether the shell has SI and whether the cartridge has SI. Based on this information, the cartridge and shell may negotiate to determine which SI to use (the shell's SI or the cartridge's SI). In this manner, a device may be able to intelligently manage SI regardless of whether the cartridge or shell contains SI.

Once the decision is made as to which SI to use, the SI may be transferred between the shell and cartridge. SI that is transferred may include roaming information and forwarding information. If a shell is in a country with a foreign network, and the shell would like to roam on the foreign network, the shell transfers roaming information to the cartridge, which in turn transfers the information to the foreign network. If the foreign network has a roaming agreement with the shell's home network, the shell is able to roam on the foreign network. Without transferring the roaming information to the cartridge, there is no information for the cartridge to send to the foreign network to validate roaming.

Forwarding information may be transferred when a prepaid cartridge is inserted into a shell that has different SI than the cartridge. For example, a shell may have a phone number of +14151234567 and a prepaid cartridge may have a phone number of +85212312345. The shell may communicate forwarding information to the cartridge, and the cartridge may communicate the forwarding information to the shell's home network so that calls directed to +14151234567 are automatically forwarded to +85212312345. This allows a shell to use a prepaid cartridge with different SI and still receive calls intended for its original SI.

Another aspect of the invention involves synchronization of user data. If both the cartridge and shell store user data (such as phone numbers and addresses), the cartridge and shell may communicate information to synchronize the user data once the cartridge is inserted into the shell. This solves the problem of which user data to access when both the shell and cartridge contain user data. Since the data is synchronized, the user can use either the user data in the shell or the user data in the cartridge since they are both the same. Furthermore, when the cartridge is removed from the shell, either the shell or cartridge may choose to revert back to the state of user data before the synchronization.

Another aspect of the invention involves a smart modular device with a locking mechanism. A shell may be locked so as to be usable with only a limited number of cartridges. This feature enables a network operator (NO) to ensure that the shell can only be used with its own cartridges. A locking mechanism also allows a cartridge to be locked from operation. The ability to lock the cartridge is useful if the cartridge is lost or stolen. If a user code-protects a cartridge, someone else who gains unintended possession of the cartridge will not be able to use it without the correct pass code.

Another aspect of the invention is a user-interface protocol allows a cartridge to exchange information with a user no matter what system software the shell is running. The protocol may define a platform-independent command that contains instructions the shell can use to ask the user for certain communication preference values. Once the user enters a value, the shell may use the protocol to communicate this value to the cartridge. Thus, a cartridge may obtain the necessary communication preference values from the user no matter what type of shell it is connected to. The protocol may also define another platform-independent command the cartridge can use to convey a message to a user. The command contains all the information a shell needs to convey the message. This enables cartridges to communicate cartridge-specific notices to the user, regardless of the cartridge's air-interface standard.

Other objects and advantages of the invention will become apparent upon further consideration of the specification and drawings. While the following description may contain many specific details describing particular embodiments of the invention, this should not be construed as limitations to the scope of the invention, but rather as an exemplification of preferred embodiments. For each aspect of the invention, many variations are possible as suggested herein that are known to those of ordinary skill in the art.

### BRIEF DESCRIPTION OF THE DRAWINGS

FIG. 1 is a block diagram that illustrates a shell connected to a cartridge. It also shows the components that may be included in a shell or cartridge.

FIG. 2 is a timing diagram that illustrates the steps the components of a smart modular wireless device may take to enable a software application to configure itself according to the wireless services in the cartridge.

FIG. 3 is a block diagram that illustrates the relationship between the cartridge, the shell, and the memory storage bins when there is subscriber information in the shell, but not in the cartridge.

FIG. 4 is a block diagram that illustrates the relationship between the cartridge, the shell, and the memory storage bins when there is subscriber information in the cartridge, but not in the shell.

FIG. 5 is a block diagram that illustrates the relationship between the cartridge, the shell, and the memory storage bins when there is subscriber information in both the cartridge and the shell.

FIG. 6 is a timing diagram that illustrates the steps a shell and cartridge may take to configure operation based on the location of subscriber information in the cartridge and shell.

FIG. 7 is a block diagram that illustrates the relationship between a SIM card, a shell, and a cartridge when the cartridge has a direct physical connection to the SIM card in the shell.

FIG. 8 is a block diagram that illustrates the relationship between a SIM card, a shell, and a cartridge when both the shell and the cartridge have a direct physical connection to the SIM card in the shell. In this diagram, there is also a switch that determines whether the shell or cartridge can access the SIM card.

FIG. 9 is a block diagram that illustrates how a memory storage bin can contain more than one subscriber storage object, each for different air-interface standards. It also illustrates how two subscriber storage objects for different air-interface standards can be in one SIM card.

### DETAILED DESCRIPTION OF THE INVENTION

A smart modular wireless device may consist of a cartridge 2 and a shell 1. The cartridge 2 may consist of wireless components such as baseband 9, RF 10, and call-processing software 11 (see prior art drawings). The shell 1 may consist of non-wireless components such as keypad 13, display 5, battery 6, speaker 4, and microphone 14. The cartridge and shell components may be located on the same circuit board 3. Alternatively, the cartridge 2 may be in the form of a wireless module or a cartridge 2 configured for removable connection to the shell 1.

The shell 1 and cartridge 2 may communicate with each other over an interface connecting the cartridge 2 and shell 1. In particular, a software driver 16 in the shell 1 may communicate with call-processing software 11 in the cartridge 2. This is illustrated in FIG. 1. The driver 16 and call-processing software 11 may use a protocol such as, but not limited to, RS-232, Universal Serial Bus, IEEE 1394, or a non-standard or proprietary protocol. The shell and cartridge may use the information exchanged to configure, reconfigure, or adapt the operation of the smart modular device.

System Software Upgrade:

A shell 1 may have system software 7 that may consist of an operating system 15 (OS), software applications 17, software drivers 16, and/or other software pieces. When a cartridge 2 is inserted into the shell 1, the shell 1 and cartridge 2 may determine whether the system software 7 in the shell 1 needs to be modified or replaced. This may be done through a recognition mechanism. The cartridge 2 and shell 1 may communicate with each other over the interface to determine what version of system software 7 is in the shell 1 and what version of replacement software is in the cartridge 2. If the system software 7 is labeled as an older version than the replacement software in the cartridge 2, the system software 7 may need to be replaced.

The cartridge 2 and shell 1 may also communicate with each other to determine which operator specified the system software 7 in the shell 1. If the system software 7 is from an operator other than the cartridge's operator, it may need to be modified.

Once it is determined that a change or replacement is needed, the shell 1 and cartridge 2 may enter into the download phase. The shell 1 may prepare to receive the replacement software and indicate to the cartridge 2 to send the replacement software over the interface. The shell 1 may receive the replacement software and save it to internal memory. The shell 1 may replace the system software 7 already in the shell 1 with the replacement software. Or, the shell 1 may modify or add to the system software 7 using the replacement software. The shell 1 may need to be “rebooted” after the download happens to activate the replacement software.

For example, a user may have a shell 1 that has system software 7 made for the Verizon network. The user may want to use the shell 1 with a Sprint PCS cartridge. The user may insert the Sprint PCS cartridge into the shell 1. The shell 1 and cartridge 2 may exchange information over the interface and determine that the Verizion system software 7 in the shell 1 needs to be replaced. The shell 1 may receive the replacement software from the cartridge 2. The user may reboot the shell 1 to activate the replacement software usable with the Sprint network.

In one embodiment, the shell 1 and cartridge 2 go through the following steps to upgrade system software. Step 1: shell 1 sends information to cartridge 2 that contains the version number and operator identification of the system software 7. Step 2: the cartridge 2 compares the system software's version number and operator ID to the version number and operator ID of the replacement software. Step 3: the cartridge 2 determines if the system software 7 needs to be replaced. Step 4a: if the system software 7 does not need to be replaced, the cartridge 2 does nothing. Step 4b: if the system software 7 does need to be replaced, the cartridge 2 communicates to the shell 1 to start the download process for replacing the system software 7. Step 5: the shell 1 tells the cartridge 2 to start sending the replacement software to the shell 1. Step 6: the cartridge 2 sends the replacement software to the shell 1. Step 7: the shell 1 saves the replacement software in memory and reboots.

Re-Configurable Software Application:

A software application 17 (“application”) resident on the shell 1 may register with the shell operating system 15 (“shell OS”) for various wireless services. This registration may give the shell OS 15 information on which wireless services the application 17 is looking for. For example, an instant messaging application 17 may register for a 2-way packet data wireless service in order to enable its instant messaging operation.

The shell OS 15 may store the application's registration information in memory along with registration information from other applications. When the requested wireless service becomes available (i.e.—a cartridge 2 is inserted that supports the wireless service or a cartridge 2 adds the wireless service due to reconfiguration of a software-defined radio), the shell OS 15 may use the stored registration information to notify the application 17 that the service is now available.

Once a wireless service is available, the application 17 may send data to the service. The application 17 may do this by encapsulating the data in a command that contains, among other information, the data and the ID of the service. The command may be sent to the shell OS 15. The shell OS 15 may add information to this command and send the modified command to the cartridge 2 through a software driver 16 in the shell 1. The cartridge 2 may receive the command and give the application's data to the specified wireless service for sending to a wireless network.

During registration, the shell OS 15 may assign the application 17 a client ID number and store the client ID in a service request list (or lists) or other storage mechanism. When a wireless service becomes available, the shell OS 15 may look through the storage mechanism to find which client IDs desire the service. The shell OS 15 may notify the applications corresponding to these client IDs that the service is available. The application 17 may then start communicating with the particular service in the cartridge 2.

In one embodiment, an application 17 may use the following function to register for wireless service:

RegisterForHydraService(<service number>, <prefs>)

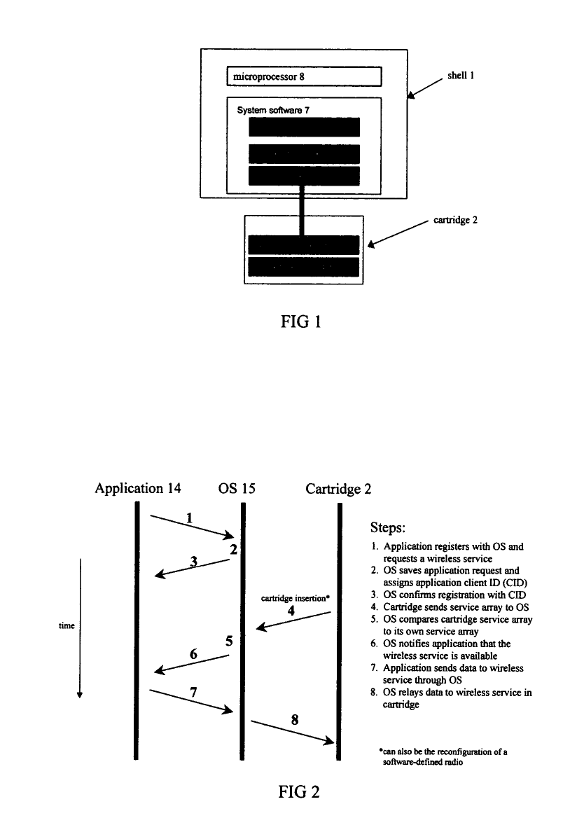

This function call is illustrated in the timing diagram of FIG. 2 step 1. When this function is called, the shell OS 15 may receive the function parameters and assign the application 17 a client ID. This is shown in FIG. 2 step 2. It may store this client ID in a registration list. The shell OS 15 may now communicate with the application 17 through the function's return call, which can be synchronous or asynchronous. The return value for the function call may be the client ID to indicate registration success. This is illustrated in FIG. 2 step 3.

The service number parameter may designate the wireless service desired by the application 17. The shell OS 15 may maintain an array of elements called the service array, wherein each element may represent a service. The service number may be the index into the array, starting at 0. Wireless service 0 may be the first element of the array, service1 the second element, and so on. The service array does not have to be an array, but may be any other data structure for storing similar data elements. Consider the following service array:

[<a>, b>, <c>, . . . ]

In this service array, <a>, element 0 of the list, may correspond to service number 0. <b>, element 1 of the list, may correspond to service number 1, and so on. The elements in the array may represent all the wireless services known by the shell 1 regardless of whether the service is supported by the shell or not. If the service is not supported, the corresponding element value may be 0. If the service is available, the number may be>0, where the exact value of the element may specify the nature of the service (such as speed or other defining characteristic).

The shell OS 15 may also maintain registration lists for each wireless service represented in the service array. List 0 may correspond to service0, and so on. During registration, the shell OS 15 may insert the client ID of the application 17 into the registration list corresponding to the service number desired by the application 17. This may enable the shell OS 15 to remember which applications want which services. Registration lists may be any kind of storage mechanism.

If the service number requested by the registering application 17 is not in the service array (for example, it indexes beyond the array), the application 17 may be asking for a service the shell 1 does not know about. In this case the shell OS 15 may be able to expand the service array to add this new service number. It may also create a new registration list that corresponds to the new service number. It may add the client ID to the new registration list.

For example, a service array of [1,0,2] may signify that service0 is supported with a value of 1, service1 is not supported, and service2 is supported with value 2. If the service number requested by the application 17 is 4, the shell OS 15 may update the service array to this: [1,0,2,0,0]. This new array may signify that the shell 1 now knows about five services (service0 through service4). The last two are not supported by the current shell/cartridge combination, but could be supported in the future. The shell OS 15 may also create a new registration list for service4 and insert the application's client ID into this registration list.

When a new cartridge 2 is inserted into the shell 1 (or when a cartridge reconfigures its SDR), the cartridge 2 may tell the shell 1 which wireless services is supports (specifically, the call-processing software 11 in the cartridge 2 may communicate with the shell driver 16, which in turn communicates with the shell OS 15). This is shown in FIG. 2 step 4. The shell OS 15 may then notify the registered applications which services are available and which services are not (FIG. 2 step 6).

In some cases, the shell OS 15 may maintain a default service array that describes which services the shell 1 is able to support given its current hardware configuration. For example, if service0 corresponds to voice, a value >0 for service0 may mean the shell 1 contains the speaker 4 and microphone 14 hardware required to support voice service. The shell OS 15 may send this default array to the newly inserted cartridge 2. For example, the shell OS 15 can send the default array [1,0,2,0,0] to the cartridge 2. Based on the default array, the cartridge 2 may send another service array back to the shell OS 15 that tells the shell OS 15 which services will be supported by the shell/cartridge combination.

For example, suppose a cartridge 2 supports six wireless services 0-5. The two-way radio service with index value of 3 requires a special two-way button on the shell 1. However, the other services 0-2 and 4-5 do not require special hardware in the shell 1. The shell 1 sends service array [1,0,2,0,0] to the cartridge 2, indicating it has hardware support for services 0 and 2. It is also indicating the shell 1 does not know about service5 since there are only 5 elements to the service array. The cartridge 2 sends [1,1,2,0,1,1] in response, to indicate to the shell 1 that the cartridge 2 supports the services 0-4 the shell 1 knows about, plus a new service5. However, since service3 requires special hardware, it cannot be supported by the shell/cartridge combination. Service 1, service4, and even new service5 do not require special hardware so the combination can use them. Once the shell OS 15 receives this final service array from the cartridge 2, it notifies the applications that registered for services 0, 1, 2, 4, and 5 that the services are now available. The shell OS 15 may also send these applications the service value (2 for service2 and 1 for the others) of the new service. The shell OS 15 may even notify applications that service3 is not available. This example illustrates one way service arrays can be used to determine availability of services. Other ways are possible as well.

Once an application 17 is notified by the OS 15, it may decide whether to use the service in the cartridge 2 based on the value of the service. Applications 17 on the shell 1 may communicate with services in the cartridge 2 by sending data to the shell OS 15 with a specific service number. This is illustrated in FIG. 2 step 7. The shell OS 15 may relay the data from the application 17 to the cartridge 2 using the client ID and the service number (FIG. 2 step 8). Likewise, a service in a cartridge 2 may send data to the shell OS 15 using a service number and client ID. The shell OS 15 may relay this data to the application 17 that corresponds to the client ID.

Subscriber Information Management:

Both the cartridge 2 and shell 1 may contain at least one memory storage bin 22 (“bin”) to store subscriber information 24 (SI). SI 24 may include several types of data. SI 24 that uniquely describes the user may be an International Mobile Subscriber Identification (IMSI) number. Other forms of subscriber information 24 may include Mobile Identification Number (MIN), Temporary Mobile Station Identity (TMSI), Mobile Directory Number (MDN), System Identification (SID), Network Identification (NID), and Mobile Network Code (MNC). In some cases, SI 24 may also include Equipment Information (EI) that uniquely describes the cartridge 2 such as an Electronic Serial Number (ESN) or International Mobile Equipment Identifier (IMEI). Other types of SI 24 are possible as well.

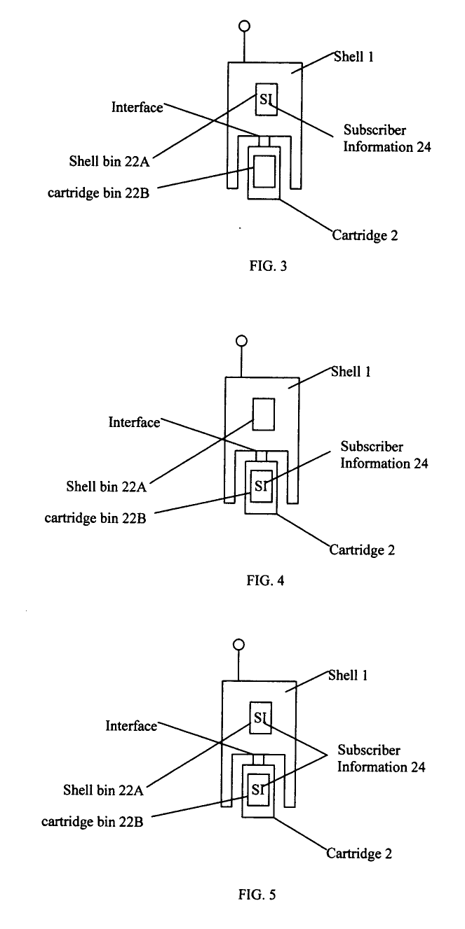

There are four cases that are possible with this dual SI bin 22 architecture. In the first case, the shell 1 contains the subscriber info 24 and the cartridge 2 does not FIG. 3 provides a block-diagram illustration of this case. The shell 1 and cartridge 2 may communicate over the interface to relay subscriber info 24 from the shell 1 to the cartridge 2 so the cartridge 2 can relay this information to the base station when requested. Either the shell 1 or the cartridge 2 may initiate this SI communication. For example, the cartridge 2, finding no SI 24 in its own bin 22B, may send a query message to the shell 1 to get the SI 24. Alternatively, the shell 1 may send SI 24 to the cartridge 2 without prompting, allowing the cartridge 2 to decide whether to use it or not. After the SI communication, the shell 1 may send a message telling the user which SI 24 (shell 1 or cartridge 2) is being used. The user may also query the shell 1 to find the location of the SI 24 being used. There are several methods the shell 1 and cartridge 2 can use to communicate SI 24. These are described later.

In the second case, the cartridge 2 contains the subscriber info 24 and the shell 1 does not. FIG. 4 provides a block-diagram illustration of this case. The shell 1 and cartridge 2 may communicate over the interface to make sure both the cartridge 2 and the shell 1 know that the SI 24 is in the cartridge 2 and not the shell 1. Either the shell 1 or the cartridge 2 can initiate this status-finding communication. For example, the shell 1, finding no SI 24 in its own bin 22A, may send a query message to the cartridge 2 to make sure the cartridge 2 has the SI 24. Alternatively, the cartridge 2 may query the shell 1 to see if it should use the SI 24 in the shell 1 or the cartridge 2 (in this case the cartridge SI 24 will be used because there is no SI 24 in the shell 1). After the SI status-finding communication, the shell 1 may send a message telling the user that the SI 24 in the cartridge 2 is being used. The user may also query the shell 1 to find the location of the SI 24 being used.

In the third case, both the cartridge and shell bins 22B and 22A contain subscriber information 24. FIG. 5 provides a block-diagram illustration of this case. The SI 24 may be the same, or may be different. The shell 1 and cartridge 2 may communicate over the interface to find that both bins 22A and 22B contain subscriber info 24. Then, the shell 1 and cartridge 2 may negotiate (again by communicating over the interface) to determine with SI 24 to use. In the preferred embodiment, the SI 24 in the shell 1 is used over the SI 24 in the cartridge 2. This is to maintain consistent identity when cartridges are interchanged. If the SI 24 in the shell bin 22A is to be used, the shell 1 may communicate the necessary SI 24 to the cartridge 2 as happens in case 1 above. Once the cartridge 2 and shell 1 determine which SI 24 to use, the shell 1 may send a message telling the user that there are two sets of SI 24 and which SI 24 is being used. The user may also query the shell 1 to find this information.

In the fourth case, there is no subscriber information 24 in either the shell or cartridge bin 22A and 22B. The shell 1 and cartridge 2 may communicate over the interface to find that there is no SI 24. Wireless communications may not be possible without subscriber info 24, in which case the shell 1 may communicate to the user that there is no SI 24 in either the cartridge 2 or shell 1 and this situation needs to be remedied.

There are many different types of bins 22 for holding subscriber information 24. Often, the type of bin 22 depends on the wireless standard being used. Some bins 22 may actually be combinations of bins (when multiple standards need to be supported). In come cases, a bin 22 may be a removable memory component such as a SIM card 18. For example, a GSM cartridge 2 may hold SI 24 in a SIM card 18. A shell 1 may also hold SI 24 in a SIM card. In other cases, a bin 22 may consist of embedded memory 25 in the shell 1 or cartridge 2. A PDC cartridge 2 may hold SI 24 in embedded memory 25 in the cartridge 2. Some shells and cartridges may use bins 22 that are actually combinations of removable and embedded memory 25. For example, a shell 1 that needs to contain subscriber information 24 for both GSM and PDC may hold GSM SI 24 in a SIM card 18 and PDC SI 24 in embedded memory 25 in the shell 1.

SI Querying: A cartridge 2 and shell 1 may use a technique called SI querying to determine which bins 22 contain subscriber info 24 (i.e.—which of the above four cases is being dealt with). This may be accomplished by passing query and status messages back and forth over the interface. Any communication protocol may be used for SI querying, and the method used will most likely be consistent with the communication protocol used for SI negotiation or SI transfer. For example, the cartridge 2 and shell 1 may use the AT command structure over serial data lines as the communication protocol. Since communications protocols for exchanging query and status messages are well known in the industry, they will not be discussed here.

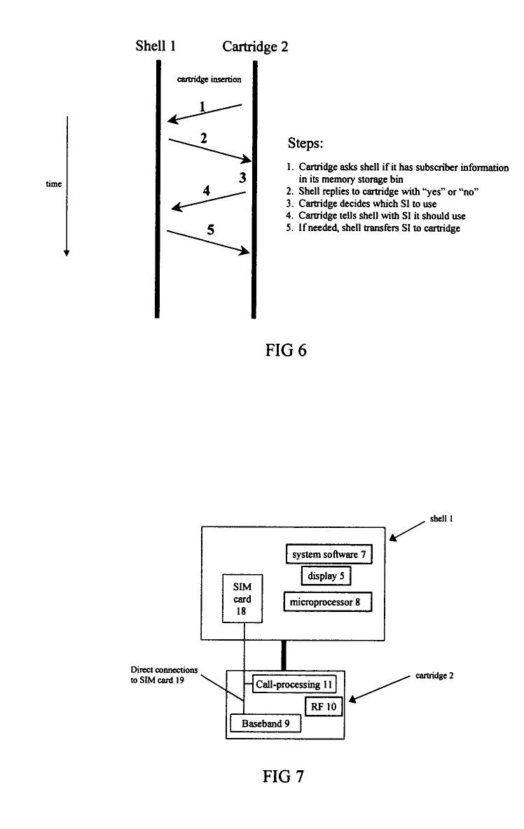

As is common in industry practice, either the cartridge 2 or shell 1 may initiate SI Querying (i.e.—send the first message). In one embodiment, illustrated by FIG. 6, the cartridge 2 sends a message to the shell 1 asking if the shell 1 has SI 24 (step 1). The shell 1 may send a message to the cartridge 2 indicating whether it has SI 24 in the shell bin 22A (step 2). The cartridge 2 may check to see if it has SI 24 in its cartridge bin 22B and then decide which SI 24 to use (step 3). The cartridge 2 may then tell the shell 1 which bin 22 (shell 22A, cartridge 22B, or neither) will be used (step 4). In another embodiment, the cartridge 2 may query the shell 1 to see if there is SI 24 in the shell bin 22A. Based on the response from the shell 1, the cartridge 2 may decide which SI 24 to use (if any) and communicate this decision to the shell 1.

SI Negotiation: the process of deciding which SI 24 to use may be called SI Negotiation. SI negotiation may be performed by either the shell 1 or the cartridge 2. The illustration in FIG. 6 shows when a cartridge 2 may perform the negotiation calculation (step 3). In one embodiment, the cartridge 2 always chooses the SI 24 in the shell 1 (for roaming purposes) and communicates this decision to the shell 1 (step 4).

SI Transfer is the process whereby SI 24 is transferred from the shell 1 to the cartridge 2. It is illustrated in FIG. 6 step 5. There are different ways for the shell 1 to communicate subscriber information 24 to the cartridge 2. In one embodiment, the shell bin 22A may contain a SIM card 18. The cartridge 2 may have a direct connection 19 to a SIM card 18 in the shell 1, in which case the cartridge 2 may perform the SI Transfer by communicating directly with the SIM card 18. This simple embodiment is illustrated by the block diagram in FIG. 7. Or, the SIM card 18 in the shell 1 may be connected to an address/data bus that the cartridge 2 has access to via pins on the interface. The cartridge 2 may still have direct access to the SIM card 18, but must access the SIM card 18 through the bus.

In another embodiment the shell 1 contains a SIM card 18 but the cartridge 2 does not have direct access to it. The shell 1 may access the data on the SIM card 18 and transfer this information to the cartridge 2 via a communications protocol over the interface. Unlike the previous embodiment where the shell 1 has no role in the SI transfer, in this embodiment the shell 1 acts as an intermediary between the shell SIM card 18 and the cartridge 2. This might be desirable if the shell 1 needs access to the SIM card 18 as well, either for SI 24 or user data such as stored phone numbers.

In yet another embodiment, both the shell 1 and cartridge 2 have a direct connection 19 to the SIM card 18 in the shell 1, but an electronic switch 20 switches the SIM card access rights between the shell 1 and cartridge 2. This electronic switch 20 may be controlled by a microprocessor 8 in the shell 1 via a control bus 21, as illustrated in the block diagram in FIG. 8.

In some cases, subscriber info 24 in the shell 1 is not contained on a SIM card 18. For example, the IS-136 (TDMA) standard does not use SIM cards. Instead, this SI 24 may be contained in embedded memory 25 in the shell 1. This information may be communicated to the cartridge 2 via a data communications protocol over the interface. Any data communications protocol may be used; AT commands over serial data lines, a proprietary packet structure, or any other protocol.

SIM card SI 24 is specifically delineated by standards documents to make roaming easy. For example, CDMA and GSM require SI 24 to have a set structure on the SIM card 18. Unfortunately, non-SIM card SI structure is not as standardized. To make roaming easier with non-SIM card SI 24 (such as TDMA SI), a modular wireless device may organize such information into flexible yet comprehensive formats.

Non-SIM card subscriber information 24 may be termed as any kind of SI 24 that is not stored on a SIM card 18. There are many cases where this kind of information needs to be stored. For instance, if a shell 1 uses a TDMA system as its home network, the user's subscriber info 24 will be specific to TDMA and therefore cannot be contained on a SIM card 18 because TDMA does not support SIM cards.

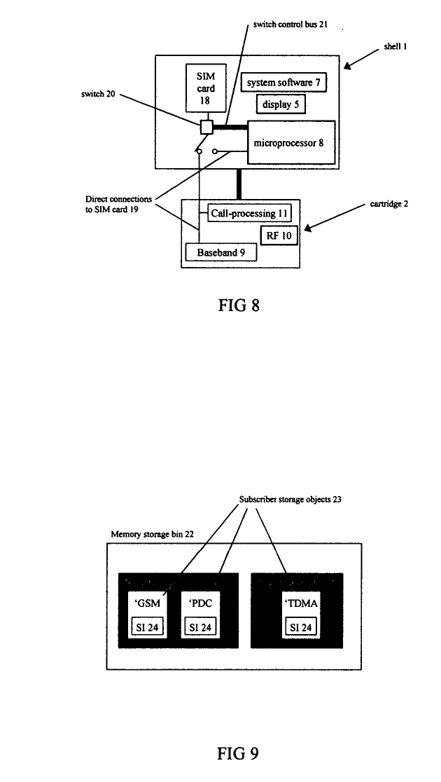

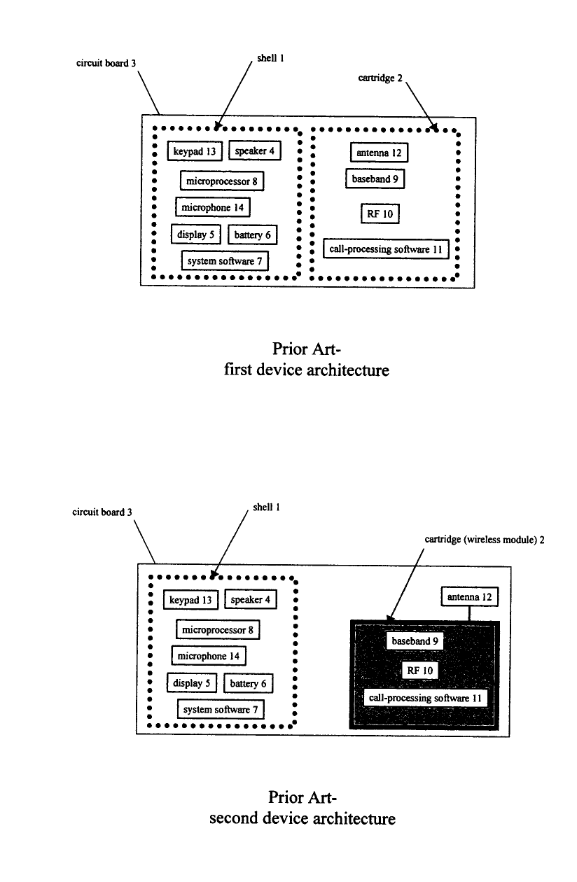

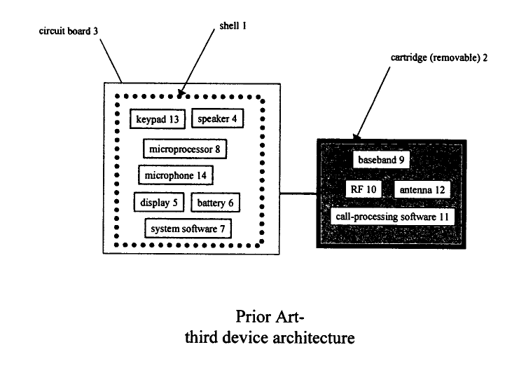

Non-SIM SI 24 may be stored in subscriber storage objects 23. FIG. 9 provides a block-diagram illustration of this concept. A subscriber storage object 23 (SSO) may simply be a data structure in which a shell 1 can store SI 24 in a bin 22. A SSO 23 may have a type field that specifies which standard the SSO 23 is associated with. For example, an SSO 23 that contains SI 24 for a PDC network may have a “PDC” type field. There are many ways of “typing” a structure, so the typing method is not important. (Incidentally, it should be known that SIM cards store SI 24 in specific structures as well. Each standard, such as GSM and CDMA, specifies its own structure for storing SI 24 on a SIM card 18. These structures can also be described as a certain type of SSO 23. Standards documents such as TLA/EIA/IS-820 and ETSI TS 100 977 are incorporated here as a reference in their entirety to describe the format of these SSOs.)

As seen in FIG. 9, a memory storage bin 22 may have more than one subscriber storage object 23. For example, a shell 1 may have two phone numbers. Or, a shell 1 may support two air-interface standards that have incompatible SI structures. Both embedded memory 25 or SIM cards 18 can store multiple SSOs 23.

SI transfer occurs when the shell 1 sends SI 24 to the cartridge 2 so the cartridge 2 can relay the information to a network. In SI transfer, the shell 1 may bundle information from an SSO 23 into a SI transfer object (STO) for sending to the cartridge 2. This STO may have the exact same structure and contain the exact same information as the SSO 23 from which it was constructed, or it may have a different structure, or be a subset or superset of the SSO 23. STOs may also be constructed from SIM card SI 24. (the shell 1 accesses the SIM card 18 and builds an STO based on SI 24 in the SIM.) The STO may also be typed to specify the standard it is associated with.

Although STOs can store a wide variety of information, two types of information will be mentioned here. The first kind is “roaming information”, which is all the SI 24 that is needed to allow the shell 1 to roam on a visited network (assuming the visited network and the home network have a roaming agreement in place). For example, let us assume that J-Phone and Vodafone have a roaming agreement. If a J-Phone PDC subscriber is roaming on a Vodafone GSM network in Australia with a GSM cartridge 2, the shell 1 and cartridge 2 need to relay data to the base station so the GSM network can verify that the PDC subscriber has roaming access to the GSM network. This information may include the IMSI or MIN, but is highly dependent on the requirements of each network. In order to accomplish roaming, the shell 1 sends its roaming SI 24 to the cartridge 2 in a STO. The cartridge 2 receives the STO and extracts the needed roaming information. Thereafter, the cartridge 2 uses the same techniques in current art handsets to obtain roaming permission from the visited network.

The second kind of STO data is “forwarding information”. There are some cases where a shell 1 cannot roam on a visited network using the shell SI 24. This may be because the visited network does not have a roaming agreement with the shell's home network. Or, it may be because the user has not opted for international roaming. In these cases, the user may obtain an additional cartridge 2 provided by the visited network (such as a pre-paid cartridge 2) that gives the user access to the visited network using SI 24 in the additional cartridge 2 (such as a new phone number). However, the user may desire to receive calls directed not only to the new SI 24 in the additional cartridge 2, but also to SI 24 used by the shell on its home network. For example, suppose the shell's home network SI 24 has the phone number of +1.415.123.4567. A prepaid cartridge 2 is inserted into the shell 1 that has a phone number of +852.123.12345. The user would like to receive calls directed not only to +852.123.12345, but also to +1.415.123.4567. Since the device can only have one SI 24 active, this cannot be done. This invention provides a way for the shell 1 to communicate to the home network the proper forwarding information so that calls to the home network phone number (+1.415.123.4567) get forwarded to the new temporary phone number on the visited network (+852.123.12345).

In one embodiment, the shell 1 sends forwarding information to the cartridge 2 in a STO. This information needed in the STO is highly dependent on the home network. For some networks, it may only include the shell's phone number and the cartridge's phone number. For other networks, it may also include the home network ID. The specifics of the forwarding information are not important to this invention and are already well known to those practiced in the art. When the cartridge 2 receives the required forwarding information, it uses techniques already used by those practiced in the art to forward all calls directed to the shell's phone number to the cartridge's phone number. The forwarding information may contain data structures that are forwarded on to the home network without any processing by the visited network. There may be different types of data structures depending on what communications protocol is being used to communicate with the home network (such as SS7). The result is that the shell 1 and additional cartridge 2 combination receive calls for both the shell's phone number and the additional cartridge's phone number.

In another embodiment, the forwarding information may contain executables so that the visiting or home network need merely run the executable to perform the forwarding operation. Executables may be written in Java or any other remote executable format.

There are many ways to format an STO and many ways for the shell 1 to transfer an STO to the cartridge 2. The following AT Commands may be used by the shell 1 to communicate SI 24 to the cartridge 2:

+CIMI

| This command tells the cartridge 2 the subscriber ID of the shell 1: | |
|---|---|
| +CIMI = <IMSI> | // see GSM 07.07 5.6 for details |

+HOPS

This command tells the cartridge 2 the Home Network/Carrier ID.
+HOPS = [<format>, <oper>]

These commands show only one way of structuring a STO and sending it to the cartridge 2. They have the benefit of being part of a well-known protocol already standardized by GSM. However, a proprietary STO format and transfer mechanism may be much more extensible and efficient.

The following is a description of the interaction between cartridge 2 and shell 1 for several invention embodiments. This will show how the above aspects of this invention may be implemented.

Embodiment 1:

1. A cartridge 2 is inserted into a shell 1. The cartridge 2 contains a SIM card 18, as does the shell 1.

2. Upon insertion, the shell 1 sends a message to the cartridge 2 over the interface saying it has a SIM card 18.

3. The cartridge 2 gets this message, and replies to the shell 1 that the shell SIM card 18 will be used for subscriber info 24.

4. The cartridge 2 has a direct connection 19 to the SIM card 18 via interface pins or an address/data bus, so accesses the shell SIM card subscriber info 24 using this connection.

Embodiment 2:

1. A cartridge 2 is inserted into a shell 1. The shell 1 does not contain a SIM card 18, but contains a Non-SIM card SSO 23.

2. The shell 1 communicates to the cartridge 2 that it has an SSO 23 and no SIM card 18.

3. The cartridge 2 asks the shell 1 to send the SSO 23.

4. The shell 1 sends the SSO 23 to the cartridge 2 in the form of an STO, and the cartridge 2 relays this information to the base station. The base station either uses the roaming information in the STO and/or the forwarding information.

Embodiment 3:

1. A cartridge 2 is inserted into a shell 1. The shell 1 contains both a SIM card 18 and a non-SIM card SSO 23. The cartridge 2 contains no SIM card 18.

2. The shell 1 tells the cartridge 2 that it has both a SIM card 18 and an SSO 23.

3. The cartridge 2 asks the shell 1 to send the SSO 23 because it does not know how to use SIM cards (for example, it is a TDMA cartridge).

4. The shell 1 sends the SSO 23 to the cartridge 2 in the form of an STO, and the cartridge 2 relays this information to the base station. The base station either uses the roaming information in the STO and/or the forwarding information.

User-Data Synchronization—

Some modular devices may have two SIM cards to store user data such as phone numbers. One of the SIM cards may be stored in the shell 1 and the other may be stored in the cartridge 2. When the cartridge 2 is attached to the shell 1 through the interface, the two components may exchange information to synchronize the data on the two SIM cards so the user data on both components is the same. Any synchronization algorithm may be used to do the synchronization. In one embodiment, one or both SIM cards may save the state of their user data prior to synchronization, and return to their respective saved prior states after the connection between the two SIM cards is broken (i.e.—the cartridge 2 is removed from the shell 1). In another embodiment, only one (the “first”) SIM card's data is changed based on new or different data in the second SIM card. The second SIM card remains unchanged. The shell 1 then uses the first SIM card's data for displaying user data. The shell 1 ignores the second SIM card for user data.

Other embodiments of this shell/cartridge synchronization may include other storage mediums such as removable memory cards or embedded memory 25.

Locking Mechanism:

The shell 1 of a smart modular device may have two states: locked and unlocked. When in the unlocked state, the shell 1 is operable with any cartridge 2 inserted into the shell 1. When in the locked state, the shell 1 cannot be used with a cartridge 2. To use the shell 1 with a cartridge 2, the shell 1 needs to be returned to the unlocked state. Returning a shell 1 to the unlocked state may be accomplished by many methods, including but not limited to:

User enters a pass code into the shell 1 to move the shell 1 to the unlocked state. The pass code query may appear when the user tries to operate the shell 1. Depending on how the lock is implemented in the shell 1, the shell 1 may either stay in the unlocked state after the cartridge 2 is removed or return back to the locked state until the user re-enters the correct pass code.

When a cartridge 2 is inserted into the locked shell 1, the cartridge 2 and shell 1 may exchange information across the interface. In this exchange, the shell 1 may communicate to the cartridge 2 that the shell 1 is locked. The cartridge 2 may provide the shell 1 with a pass code (such as a number) that moves the shell 1 to the unlocked state, making the shell 1 operable with the cartridge 2.

If the pass code is not correct, the shell 1 remains in the locked state. The shell 1 may return to the locked state after the cartridge 2 is removed. The wireless network may communicate the proper pass code to the cartridge 2 wirelessly.

Putting the shell 1 into the locked state may be accomplished by many means. A shell 1 may default to the locked state upon power-up. The user may lock the shell 1 through an application 17 contained in the shell 1. This application 17 may query the user to enter the pass code required to unlock the shell 1.

A cartridge 2 of a smart modular device may have two states; locked and unlocked. In the locked state, wireless services in the cartridge 2 are disabled. In the unlocked state, wireless services in the cartridge 2 are enabled. To move a cartridge 2 into the unlocked state (unlock the cartridge 2), several methods may be employed, including but not limited to:

When the cartridge 2 is inserted in the shell 1, the cartridge 2 and shell 1 may exchange information. The cartridge 2 may communicate to the shell 1 that it is locked. The shell 1 may give the cartridge 2 a pass code to unlock the cartridge 2. The shell 1 may ask the user to input a pass code to unlock the cartridge 2. If the cartridge 2 is removed from the shell 1, the cartridge 2 may either return to the locked state or remain in the unlocked state. The behavior of the cartridge 2 upon removal may be determined by a setting in the cartridge 2 that is changeable by the user through the shell 1.

The network may send a pass code to the cartridge 2 wirelessly to unlock the cartridge 2. The cartridge 2 may lose or retain its unlocked state when removed from the shell 1.

The shell 1 and cartridge 2 may have the same pass code. This pass code may be entered into the shell 1 to unlock both the shell 1 and the cartridge 2 at the same time.

User-Interface Protocol:

The information passed between the shell 1 and cartridge 2 may be used to relay data between the cartridge 2 and the user of the device. Upon insertion of a cartridge 2 into a shell 1 (or upon a cartridge reconfiguring its SDR), the cartridge 2 and shell 1 may exchange information over the interface to determine if the cartridge 2 requires any communication preference values in order to operate. For example, for SMS service a cartridge 2 may need to know the phone number of the SMS message center. For Internet access, the user may need to enter an IP or DNS server address.

If the cartridge 2 does require preference values, the cartridge 2 may send the shell 1 information that instructs the shell 1 how to get the values from the user. This information may include the name of the value (e.g.—“IP address”) and the format of the value (e.g.—“xxx.xxx.xxx.xxx”). The shell 1 may use this information to create a user-interface element that allows the user to enter the preference value required by the cartridge 2. Once the user enters the preference value, the shell 1 may communicate the value to the cartridge 2 so the cartridge 2 can operate.

If the shell 1 requests a service in the cartridge 2, yet the required preference values have not been given to the cartridge 2, the cartridge 2 may respond to the shell 1 that the wireless service is not available until the shell 1 sends the proper values.

In one embodiment the shell 1 may send the cartridge 2 the following command to ask the cartridge 2 what preference values are needed:

AT+HPF=?<s0>, <s1>, . . . <sn>

where <s> may be the service indexes of the services the cartridge 2 supports. There may be just one or more than one index in the command. The cartridge 2 may respond to this command with result codes in the following format:

+HPF: <s>, (“label”, “format”), (“label”, “format”)

where <s> may be the service index the result code applies to, the “label” string may be the name of the individual preference value (like “IP address”) and “format” may be a string that describes the format of the preference value (like “Xxx.Xxx.Xxx.Xxx”). There may be more than one “label/format” combination if the cartridge 2 needs several preference values for a particular service. There may be more than one result code if the shell 1 requested preference information on more than one service.

The format string may contain characters that are predominantly “x” characters to allow the user to enter any value, but may also use other characters to signify the type of values that should be entered. For example, an upper-case character may signify that the user is required to enter a value (e.g.—“XXX” means the user must enter 3 characters). Lower-case may signify the character is optional (“Xxx” means the user can enter 1 to 3 characters). “n” may signify that the input must be a number, from 0-9. A letter like “h” or “H” may signify that the user-interface element must hide the data entered by the user (e.g.—passwords show up as “******” instead of “mypswd”). In addition, the format string may contain non-input characters that aid the user in inputting values. For example, “.” in the string format may help users enter IP addresses, “(” and “)” may help users enter US area code values as part of a phone number.

When the shell 1 receives these result codes from the cartridge 2, it may construct, according to the result code, a user-interface element that allows the user to enter the desired values. The user-interface element may be a window with fields the user can use to enter values. The window may pop up automatically so the user can enter values right away. Once the user enters preference values into the user-interface element, the shell 1 may relay these values to the cartridge 2 with the following command:

AT+HPF=<s>, (label, value), (label, value), . . .

This command may have the same structure as the result code from the cartridge 2 except for the “AT” and the “=”. Also, instead of inserting the format string after the label, the actual value the user entered may be inserted instead. For example, a label/value combination may look like this—(“IP address”, “204.247.0.18”).

Using this mechanism, all the information desired by the cartridge 2 may be obtained through the shell's user-interface.

From time to time, the cartridge 2 may want to convey status information to the user. The cartridge 2 may send the shell 1 unprompted result codes that allow the shell 1 to notify the user of a change in status in the cartridge 2. The codes may contain strings that the shell 1 can use to build a user-interface element that notifies the user of the status. In one embodiment, the code may look like this:

+HN: (title, text)

where “title” is a string that describes the status and “text” is the information the cartridge 2 wants to convey to the user. Upon receiving this code, the shell 1 may pop up a notify window that contains the title and the text.

While the present invention has been described with reference to the aforementioned applications explained in detail above, these descriptions and illustrations of the preferred embodiments and methods are not meant to be construed in a limiting sense. It shall be understood that all aspects of the present invention are not limited to the specific depictions, configurations or relative proportions set forth herein which depend upon a variety of conditions and variables. Various modifications in form and detail of the various embodiments of the disclosed invention, as well as other variations of the present invention, will be apparent to a person skilled in the art upon reference to the present disclosure. It is therefore contemplated that the appended claims shall cover any such modifications, variations or equivalents of the described embodiments as falling within the true spirit and scope of the present invention.

What is claimed is:

1. A modular wireless device comprising:
a shell that contains non-wireless components, at least of one of which is system software; and
a cartridge that contains wireless components, at least one of which is call-processing software; and
a means for the shell and cartridge to exchange information; and
a means for the modular wireless device to configure its operation based on said information.

2. The modular wireless device as recited in claim 1 wherein the cartridge is removably connected to the shell.

3. The modular wireless device as recited in claim 1 wherein the shell contains a keypad, display, and microprocessor and the cartridge contains baseband and RF components.

4. The modular wireless device as recited in claim 2 wherein:
the cartridge further includes replacement software; and
the modular wireless device further includes means for transferring the replacement software to the shell to upgrade, augment, or replace the system software.

5. The modular wireless device as recited in claim 4 wherein;
the system software contains a first version number, and
the replacement software contains a second version number, and
wherein the cartridge and shell have a means to exchange the first and second version numbers to determine whether the system software should be replaced.

6. The modular wireless device as recited in claim 4 wherein:
the system software contains a first operator identification; and
the replacement software contains a second operator identification; and
wherein the cartridge and shell exchange the first and second operator identifications to determine whether the system software should be replaced.

7. The modular wireless device as recited in claim 1 wherein:
the system software includes a software application and an operating system; and
the system software has means for the software application to register with the operating system for a wireless service; and
the modular wireless device further includes means for the cartridge to communicate wireless service availability to the operating system; and
the operating system has means to notify the software application of the availability of a wireless service in the cartridge,
whereby the software application can configure its operation according to the wireless services available in the cartridge.

8. The modular wireless device as recited in claim 7 wherein the operating system maintains a service array that specifies which wireless services it is able to support based on the shell's hardware characteristics.

9. The modular wireless device as recited in claim 8 wherein the operating system has means for expanding the service array to incorporate new wireless services.

10. The modular wireless device as recited in claim 8 wherein:
the shell has means of obtaining the wireless services supported by the cartridge; and
the shell has means of using the service array to determine which wireless services in the cartridge the shell is able to use.

11. The modular wireless device as recited in claim 2 wherein:
the shell further includes a first memory storage bin for storing subscriber information; and
the cartridge further includes a second memory storage bin for storing subscriber information; and
the modular wireless device further includes means for subscriber information to be exchanged between the shell and cartridge.

12. The modular wireless device as recited in claim 11 wherein at least one of the memory storage bins is a SIM card.

13. The modular wireless device as recited in claim 11 wherein the information exchanged is used to determine which memory storage bins contain subscriber information.

14. The modular wireless device as recited in claim 11 further including a means for determining whether to use the subscriber information in the shell or the subscriber information in the cartridge when both the first and second memory storage bins contain subscriber information.

15. The modular wireless device as recited in claim 11 further including a means for notifying the user which subscriber information will be used.

16. The modular wireless device as recited in claim 11 wherein the cartridge is directly connected to the first memory storage bin in the shell.

17. The modular wireless device as recited in claim 11 wherein the first memory storage bin in the shell has means to store subscriber information related to more than one air-interface standard.

18. The modular wireless device as recited in claim 17 wherein the subscriber information in the first memory storage bin is typed according to the air-interface standard it corresponds to.

19. The modular wireless device as recited in claim 11 wherein the cartridge has a means for obtaining the subscriber information in the shell's memory storage bin and communicating this subscriber information to a wireless network.

20. The modular wireless device as recited in claim 19 wherein the subscriber information contains data a wireless network needs to forward calls from a first phone number to a second phone number.

21. The modular wireless device as recited in claim 20 wherein the data is an executable that the wireless network can run to forward calls from a first phone number to a second phone number.

22. The modular wireless device as recited in claim 12 wherein both memory storage bins are SIM cards; and
the SIM cards include user data; and
the modular wireless device includes means for synchronizing the user data in the SIM cards.

23. The modular wireless device as recited in claim 2 further including:
a locking mechanism in the shell that prevents the shell from accessing the wireless services in the cartridge; and
a means for unlocking the locking mechanism.

24. The modular wireless device as recited in claim 23 wherein the means for unlocking the locking mechanism consists of a user entering a pass code into the shell.

25. The modular wireless device as recited in claim 23 wherein the means for unlocking the locking mechanism consists of the cartridge communicating a pass code to the shell.

26. The modular wireless device as recited in claim 23 wherein the locking mechanism is automatically activated when the cartridge is removed from the shell.

27. The modular wireless device as recited in claim 2 further including:
a locking mechanism in the cartridge that disables wireless services in the cartridge; and
a means for unlocking the locking mechanism.

28. The modular wireless device as recited in claim 27 wherein the means for unlocking the locking mechanism consists of the shell communicating a pass code to the cartridge.

29. The modular wireless device as recited in claim 27 wherein the means for unlocking the locking mechanism consists of a wireless network communicating a pass code to the cartridge.

30. The modular wireless device as recited in claim 27 wherein the locking mechanism is automatically activated when the cartridge is removed from the shell.

31. The modular wireless device as recited in claim 2 wherein:
the modular wireless device contains means for exchanging information related to communication preference values between the shell and cartridge,
whereby the cartridge can obtain communication preference values from the user.

32. The modular wireless device as recited in claim 31 wherein the information includes the format of the desired communication preference value whereby the shell can tell the user how to enter a communication preference value.

33. The modular wireless device as recited in claim 32 wherein the format enables the cartridge to communicate to the shell that the communication preference value is optional.

34. The modular wireless device as recited in claim 32 wherein the format enables the cartridge to communicate to the shell that the communication preference value should be encrypted.

35. The modular wireless device as recited in claim 31 wherein the shell has means for communicating a communication preference value to the cartridge once the communications preference value is entered by the user.

36. The modular wireless device as recited in claim 1 wherein the cartridge and shell have means to automatically exchange information when the cartridge is inserted into the shell.

37. A modular wireless device cartridge comprising:
a cartridge that contains wireless components, at least one of which is call-processing software and another which is an interface configured for removable connection to a shell that contains non-wireless components, at least one of which is system software; and
a means for the cartridge to exchange information with said shell and configure its operation based on said information.

38. A modular wireless device comprising:
a shell that contains non-wireless components, at least of one of which is system software and another of which is an interface configured for connection to a removable cartridge that contains wireless components, at least one of which is call-processing software; and
a means for the shell to exchange information with said cartridge and configure its operation based on said information.

39. The modular wireless device as recited in claim 7 wherein the cartridge includes a software-defined radio.

40. The modular wireless device as recited in claim 31 wherein the cartridge includes a software-defined radio.
